(19) United States
(12) Patent Application Publication
(10) Pub. No.: US 2023/0215113 A1
(43) Pub. Date: Jul. 6, 2023

(54) VISUALIZATION DEVICE OF A 3D AUGMENTED OBJECT FOR DISPLAYING A PICKUP TARGET IN A MANUFACTURING PROCESS ASSEMBLY OPERATION AND THE METHOD THEREOF

(71) Applicant: METAVU Co., Ltd., Changwon-si (KR)

(72) Inventor: Jin song ROH, Changwon-si (KR)

(73) Assignee: METAVU Co., Ltd., Changwon-si (KR)

(21) Appl. No.: 17/954,348

(22) Filed: Sep. 28, 2022

(30) Foreign Application Priority Data
Dec. 31, 2021 (KR) 10-2021-0194158

(51) Int. Cl. G06T 19/00; G06F 3/01; G06V 20/50; G01C 21/20

(52) U.S. Cl. CPC G06T 19/006; G06F 3/012; G06V 20/50; G01C 21/206

(57) ABSTRACT

A visualization device of a 3D augmented object for displaying a pickup target in a manufacturing process assembly operation includes: a component information DB in which attribute information of at least one or more components is stored; a component information input that receives component information from a wearable device; a path generator that generates path information from the real-time location to the component location included in the component information by calling the data corresponding to the component information entered to the component information input from the component information DB and detecting the real-time location of the wearable device; and a direction guide that outputs a directional image and an expected distance to the component location to the wearable device, based on the path information generated by the path generator.

### BACKGROUND

The present invention relates to a visualization device of a 3D augmented object for displaying a pickup target in a manufacturing process assembly operation and the method thereof, more specifically to a visualization device of a 3D augmented object for displaying a pickup target in a manufacturing process assembly operation and the method thereof that can accurately guide the location of components required to workers at work sites.

Augmented reality is a technology that superimposes virtual objects on the real world that the user sees. It is also called mixed reality (MR) because the real world and the virtual world with additional information are combined in real time and viewed as a single image.

Augmented reality, a concept that complements the real world with the virtual world, uses virtual environment created with computer graphics, but the main role is played by the real environment. Computer graphics serve to provide additional information necessary for the real world. This means that the distinction between the real environment and the virtual screen is blurred by overlapping the 3D virtual image on the actual image the user is viewing.

Virtual reality technology allows users to immerse themselves in a virtual environment, making it impossible to see the real environment. However, augmented reality technology, in which the real environment and virtual objects are mixed, allows users to see the real environment, providing better sense of reality and additional information. For example, if you point your smartphone camera at the surroundings, information such as the location and phone number of a nearby store is displayed in a stereoscopic image.

Korean Patent Application Publication No. 10-2012-0015802, which is a prior art, discloses a vehicle components management system using augmented reality to manage faulty component information of a vehicle in conjunction with a vehicle fault diagnosis system and the method thereof, and Korean Patent Registration Publication No. 10-0593399 discloses a components maintenance system using augmented reality that identifies types of components and provides components maintenance related information and the method thereof.

However, since the conventional navigation system that provides information or location of components guides the location of the components based on the absolute location of the components, it is difficult to determine the exact location when the actual components are hidden by obstacles or the like.

Therefore, it is necessary to study a visualization device of a 3D augmented object for displaying a pickup target in a manufacturing process assembly operation and the method thereof that can accurately provide the location and information of components required to workers at work sites using augmented reality.

### SUMMARY OF THE INVENTION

The present invention aims to provide a visualization device of a 3D augmented object for displaying a pickup target in a manufacturing process assembly operation and the method thereof that not only guides the location of components entered by the operator, but also recognizes the obstacles around the operator and creates an optimal path, thereby accurately guiding the location of components over the obstacles even in a work site with many obstacles and informing the shortest route to the place where the components are located.

In addition, the present invention intends to provide a visualization device of a 3D augmented object for displaying a pickup target in a manufacturing process assembly operation and the method thereof that that can more accurately determine whether an obstacle exists between a wearable device and components by comprehensively judging whether there is an obstacle between the wearable device and the components using the position sensor, the position information of the components stored in the DB, and the distance sensor.

Another object of the present invention is to provide a visualization device of a 3D augmented object for displaying a pickup target in a manufacturing process assembly operation and the method thereof that can monitor the occurrence of a failure of the distance sensor in order to prevent the reliability of determining whether an obstacle exists from falling due to the provision of false information caused by the failure of the distance sensor.

The problems to be solved by the present invention are not limited to the problems mentioned above, and other problems to be solved by the present invention, which are not mentioned here, will be clearly understood by those of ordinary skill in the art to which the present invention belongs from the following description.

The visualization device of a 3D augmented object for displaying a pickup target in a manufacturing process assembly operation according to an embodiment of the present invention includes a component information DB in which attribute information of at least one or more components is stored; a component information input that receives component information from a wearable device; a path generator that generates path information from the real-time location to the component location included in the component information by calling the data corresponding to the component information entered to the component information input from the component information DB and detecting the real-time location of the wearable device; and a direction guide that outputs a directional image and an expected distance to the component location to the wearable device, based on the path information generated by the path generator.

In addition, the path generator includes a surrounding image collector that generates the shortest path information based on the location of the components from the real-time location of the wearable device and collects the surrounding image from the photographing means of the wearable device; an obstacle detector that analyzes the surrounding image collected from the surrounding image collector to determine whether an obstacle exists; and a shortest path generator that generates the shortest path while avoiding the obstacle recognized by the obstacle detector.

In addition, the direction guide further comprises an obstacle detection feedback unit that displays a directional image and expected distance information on the wearable device based on the shortest path generated by the path generator; and an obstacle detection feedback unit for controlling so that the directional image is displayed in a direction without an obstacle, when the direction in which the photographing means of the wearable device takes images coincides with the direction in which the component is located and an obstacle is detected between the wearable device and the component.

According to the present invention, the visualization device of a 3D augmented object for displaying a pickup target in a manufacturing process assembly operation and the method thereof can accurately inform the location of components input by the operator, including the location of the components beyond the obstacles and the shortest path to the place where the components are located by detecting obstacles around the operator and creating an optimal path, even in a work site with many obstacles.

In addition, the present invention has an effect of more accurately determining the existence of an obstacle between the wearable device and the components by comprehensively considering whether there is an obstacle between the wearable device and the components using the position sensor, the location information of the components stored in the DB, and the distance sensor.

Further, in the present invention, by monitoring the occurrence of a failure of the distance sensor, it is possible to prevent a decrease in the reliability of determining whether an obstacle exists due to provision of erroneous information, caused by a failure of the distance sensor.

### BRIEF DESCRIPTION OF THE DRAWINGS

FIG. 1 is a block diagram of a visualization device of a 3D augmented object for displaying a pickup target in a manufacturing process assembly operation according to an embodiment of the present invention.

FIG. 2 is a diagram for explaining a path generator of a visualization device of a 3D augmented object for displaying a pickup target in a manufacturing process assembly operation according to an embodiment of the present invention.

FIG. 3 is a diagram for explaining a direction guide of a visualization device of a 3D augmented object for displaying a pickup target in a manufacturing process assembly operation according to an embodiment of the present invention.

FIG. 4 is a diagram for explaining an obstacle detection feedback unit of a visualization device of a 3D augmented object for displaying a pickup target in a manufacturing process assembly operation according to an embodiment of the present invention.

### DETAILED DESCRIPTION

Hereinafter, embodiments of the present invention will be described in detail with reference to the contents described in the accompanying figures. However, the present invention is not limited or restricted by the embodiments. Like reference numerals in each figure indicate like components.

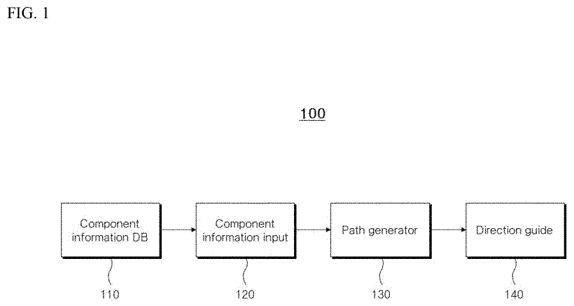

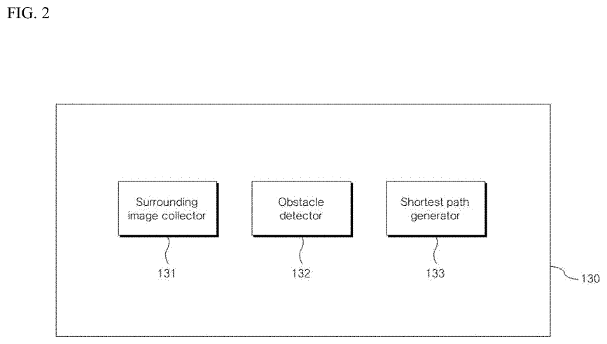

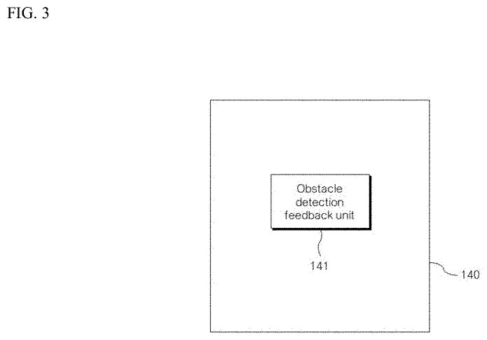

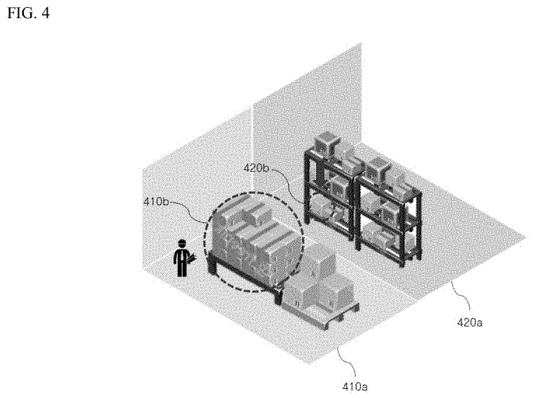

FIG. 1 is a block diagram of a visualization device of a 3D augmented object for displaying a pickup target in a manufacturing process assembly operation according to an embodiment of the present invention; FIG. 2 is a diagram for explaining a path generator of a visualization device of a 3D augmented object for displaying a pickup target in a manufacturing process assembly operation according to an embodiment of the present invention; FIG. 3 is a diagram for explaining a direction guide of a visualization device of a 3D augmented object for displaying a pickup target in a manufacturing process assembly operation according to an embodiment of the present invention; and FIG. 4 is a diagram for explaining an obstacle detection feedback unit of a visualization device of a 3D augmented object for displaying a pickup target in a manufacturing process assembly operation according to an embodiment of the present invention.

### Embodiment

Referring to FIG. 1, a visualization device of a 3D augmented object for displaying a pickup target in a manufacturing process assembly operation (100) may comprise a component information DB (110), a component information input (120), a path generator (130), and a direction guide (140.

More specifically, the component information DB (110) stores attribute information of one or more components; the component information input (120) receives component information from a wearable device; the path generator (130) calls the component information corresponding to the component information entered to the component information input (120) from the component information DB (110), detects the real-time location of the wearable device, and generates information on a path from the current location to the location of the component included in the component information; and the direction guide (140) outputs a directional image and an estimated distance to the component location to the wearable device, based on the path information generated by the path generator (130).

For example, when the wearable device, which includes a head-up display and an operation means, obtains the component information while worn by the user by identifying components through image analysis after recognizing barcodes or QR codes provided on the outer packaging of components or one side of the component storage shelf, or the component images themselves, a list of product images is transmitted to the user through the head-up display, and the user can select any one of the product images provided on the head-up display by using the operation means.

In this case, the operation means may be provided in the form of a glove and worn on the user's hand.

On the other hand, referring to FIG. 2, the path generator (130) may comprise a surrounding image collector (131) that collects surrounding images from the photographing means of the wearable device; an obstacle detector (132) that analyzes the surrounding image collected by the surrounding image collector (131) to determine whether there is an obstacle; and a shortest path generator (133) that generate the shortest path by avoiding the obstacles recognized by the obstacle detector (132).

For example, the shortest path generator (133) may extract the coordinates corresponding to the location of the wearable device and the coordinates corresponding to the location of the component, display them in a 3D virtual space, and display the obstacles recognized by the obstacle detector (132) in the 3D virtual space, thereby creating a mini-map.

Meanwhile, the obstacle detector (132) may analyze the existence of obstacles using a distance sensor in addition to the method of analyzing whether an obstacle exists through image analysis. (Image analysis and distance sensor to determine whether an obstacle exists can be used at the same time.)

That is, a distance sensor may be used to determine whether an obstacle exists between the wearable device worn by the user and the component. Hereinafter, the process of determining whether an obstacle exists using the distance sensor will be described in more detail.

First, the wearable device grasps the current location in real time through the location sensor, and the location of the component is pre-stored in the component information DB (110). Accordingly, the distance between the wearable device and the component (hereinafter referred to as “calculation distance”) may also be calculated in real time.

Besides, in the case of a wearable device equipped with a distance sensor, the distance between the wearable device and the component (hereinafter “measured distance”) may be measured by the distance sensor when the user looks at the component while wearing the wearable device.

If the error between the calculated distance and the measured distance is within a preset range, it is determined that there is no obstacle between the wearable device and the component, whereas the error between the calculated distance and the measured distance is out of a preset range, it may be determined that an obstacle exists between the wearable device and the component.

That is, if there is an obstacle between the wearable device and the component, the distance sensor will return a value significantly smaller than the calculated distance as the measured distance, and the difference between the calculated distance and the measured distance will be out of the error range.

On the other hand, the distance sensor may malfunction due to a failure or the like. In order to figure this out right away, the obstacle detector (132) may further include a sensor monitoring unit (not shown) for determining whether the distance sensor is faulty.

Hereinafter, the method of determining the failure of the distance sensor will be described in more detail. The sensor monitoring unit (not shown) may determine that the distance sensor is malfunctioning when the average error (Aₑᵣᵣ) of the distance sensor calculated by the following Formula 1 is greater than the preset error limit (Sₑᵣᵣ).

$${A}_{err} = {T}_{aver} - ( {P}_{aver} - 1.96 \times \frac{{T}_{σ}}{\sqrt{n}} ) \qquad [ Formula 1 ]$$

where, Aₑᵣᵣ refers to average error, Tₐᵥₑᵣ to total average of the distance sensor values, Pₐᵥₑᵣ to partial average of n number of distance sensor values, and T_{σ} to total standard deviation of the distance sensor values.

More specifically, Tₐᵥₑᵣ, which is the total average of the distance sensor values, is obtained by calculating the average of a plurality of data collected during a preset period (e.g. one month) while the distance sensor operates normally, and T_{σ} is obtained by calculating the total standard deviation of values sensed among a plurality of data collected during the preset period (e.g. one month).

In addition, Pₐᵥₑᵣ, which is a partial average of n number of distance sensor values, is obtained by receiving a preset number (n) of sensor values in real time and calculating the average of the preset number (n) of sensor values in a process where the distance sensor is installed and used in the field. It corresponds to the average of some sensor values, so it can be referred to as a partial average.

At this time, if the estimated average value is calculated with 95% confidence using the partial average, the estimated average value (p) has the following range:

$$( {P}_{aver} - 1.96 \times \frac{{T}_{σ}}{\sqrt{n}} ) \leq μ \leq ( {P}_{aver} + 1.96 \times \frac{{T}_{σ}}{\sqrt{n}} )$$

Accordingly, the average error (Aₑᵣᵣ), which is the difference between the upper or lower limit of the estimated average value (μ) and the total average (Tₐᵥₑᵣ), can be calculated as in Formula 1.

Therefore, the fact that the average error (Aₑᵣᵣ) calculated by Formula 1 is greater than the preset error limit (Sₑᵣᵣ) means that it is highly likely that the preset number (n) of sensor values input in real time is incorrectly input due to a malfunction of the distance sensor. Accordingly, the sensor monitoring unit (not shown) may determine that the distance sensor is malfunctioning when the above condition is satisfied.

In addition, the shortest path generator (133) may calculate the shortest path by comparing all cases with respect to the path on the mini-map from the coordinates corresponding to the location of the wearable device to the coordinates corresponding to the location of the component.

Meanwhile, referring to FIG. 3, the direction guide (140) may further include an obstacle detection feedback unit (141).

More specifically, when the direction in which the photographing means of the wearable device takes images coincides with the direction in which the component is located and an obstacle is recognized between the wearable device and the component, the obstacle detection feedback unit (141) may control the directional image to be displayed in a direction in which there is no obstacle.

On the other hand, the process of guiding the direction of moving to the component when there is an obstacle will be described in more detail with reference to FIG. 4.

Referring to FIG. 4, when the operator is located in the first area (410a) and the component (420b) that the operator is looking for is located in the second area (420a), the direction guide unit (140) may generate a directional image that bypasses the obstacle (410b) and moves to the second area (420a) instead of generating a directional image in a direction passing through the obstacle (410b).

That is, the direction guide (140) outputs a directional image and an expected distance to the wearable device based on the shortest path generated by the shortest path generator (133), but whether there is an obstacle is determined by the obstacle detection feedback unit (141). So a directional image guiding the shortest path may be displayed differently from the actual location of the component.

For example, the obstacle detection feedback unit (141) may recognize all objects other than the component the operator wants to find as obstacles. Even if the component to be found is covered by other components, the other components are recognized as obstacles, so that it is possible to prevent the operator from mistaking the other components as the component to be found.

According to the effect of the present invention as described above, it is possible to provide a visualization device of a 3D augmented object for displaying a pickup target in a manufacturing process assembly operation that guides the location of the components entered by the operator, but recognizes the obstacles around the operator and creates the optimal path to accurately guide the location of the components located beyond the obstacles even in a work site with many obstacles and guide the shortest path to the place where the components are located.

In addition, the method of controlling a visualization device of a 3D augmented object for displaying a pickup target in a manufacturing process assembly operation according to an embodiment of the present invention may be recorded in a computer-readable medium including various program instructions for performing computer-implemented operations. The computer-readable medium may include program instructions, data files, data structures, etc. alone or in combination. The medium and program instructions may be specially designed and configured for the present invention, or may be known and available to those skilled in the art of computer software. The computer-readable recording medium includes magnetic media such as hard disks, floppy disks and magnetic tapes, optical media such as CD-ROMs and DVDs, magneto-optical disks such as floppy disks, and other hardware devices specially configured to store and execute program instructions, such as ROM, RAM, flash memory, and the like. Program instructions include not only machine language codes such as those generated by a compiler, but also high-level language codes that can be executed by a computer using an interpreter or the like.

As described above, an embodiment of the present invention has been described with reference to limited examples and figures, so the above-described embodiment does not limit the embodiments of the present invention, and various modifications and variations may be made from the descriptions by those skilled in the art to which the present invention pertains. Accordingly, an embodiment of the present invention should be understood only by the claims described below, and all equivalents or equivalent modifications thereof will fall within the scope of the spirit of the present invention.

### DESCRIPTION OF SIGNS

110: component information DB
120: component information input
130: path generator
131: surrounding image collector
132: obstacle detector
133: shortest path generator
140: user sense provider
141: obstacle detection feedback unit

What is claimed is:

1. A visualization device of a 3D augmented object for displaying a pickup target in a manufacturing process assembly operation that comprises:
a component information DB in which attribute information of at least one or more components is stored;
a component information input that receives component information from a wearable device;
a path generator that generates path information from the real-time location to the component location included in the component information by calling the data corresponding to the component information entered to the component information input from the component information DB and detecting the real-time location of the wearable device; and
a direction guide that outputs a directional image and an expected distance to the component location to the wearable device, based on the path information generated by the path generator.

2. The visualization device of claim 1,
a visualization device of a 3D augmented object for displaying a pickup target in a manufacturing process assembly operation,
wherein the path generator comprises:
a surrounding image collector that generates the shortest path information based on the location of the components from the real-time location of the wearable device and collects the surrounding image from the photographing means of the wearable device;
an obstacle detector that analyzes the surrounding image collected from the surrounding image collector to determine whether an obstacle exists; and
a shortest path generator that generates the shortest path while avoiding the obstacle recognized by the obstacle detector.

3. The visualization device of claim 2,
a visualization device of a 3D augmented object for displaying a pickup target in a manufacturing process assembly operation,
wherein the direction guide comprises:
an obstacle detection feedback unit that displays a directional image and expected distance information on the wearable device based on the shortest path generated by the path generator; and
an obstacle detection feedback unit for controlling so that the directional image is displayed in a direction without an obstacle, when the direction in which the photographing means of the wearable device takes images coincides with the direction in which the component is located and an obstacle is detected between the wearable device and the component.

4. The visualization device of claim 3,
a visualization device of a 3D augmented object for displaying a pickup target in a manufacturing process assembly operation,
wherein an obstacle detector further comprises a distance sensor for determining the existence of the obstacle; and
wherein a wearable device senses the current location in real time through location sensors, extracts the location of the component from the component information DB to calculate the distance between the wearable device and the component as the first distance, and uses the distance sensor to calculate the distance between the wearable device and the component as the second distance, and as a result,
if the error between the first distance and the second distance is within a preset range, it is determined that there is no obstacle between the wearable device and the component, but the error between the first distance and the second distance is out of the preset range, it is determined that an obstacle exists between the wearable device and the component.

5. The visualization device of claim 4,
a visualization device of a 3D augmented object for displaying a pickup target in a manufacturing process assembly operation,
wherein an obstacle detector further comprises a sensor monitoring unit for determining whether the distance sensor is faulty,
wherein the sensor monitoring unit (not shown) determines that the distance sensor is malfunctioning when the average error (Aₑᵣᵣ) of the distance sensor calculated by the Formula 1 is greater than a preset error limit (Sₑᵣᵣ).
$${A}_{err} = {T}_{aver} - ( {P}_{aver} - 1.96 \times \frac{{T}_{σ}}{\sqrt{n}} ) \qquad [ Formula 1 ]$$
(where, Aₑᵣᵣ is the average error, Tₐᵥₑᵣ is the total average of the distance sensor values, Pₐᵥₑᵣ is the partial average of n number of distance sensor values, and T_{σ} is the total standard deviation of the distance sensor values.)
